(19) United States
(12) Patent Application Publication
(10) Pub. No.: US 2014/0159855 A1
(43) Pub. Date: Jun. 12, 2014

(54) AIR HEATER FUSE FOR DIESEL ENGINES

(71) Applicants: Elvis GREGORCIC, Kobarid (SI); Janez URBAS, Tolmin (SI)

(72) Inventors: Elvis GREGORCIC, Kobarid (SI); Janez URBAS, Tolmin (SI)

(73) Assignee: HIDRIA AET DRUZBA ZA PROIZVODNJO VZIGNIH SISTEMOV IN ELEKTRONIKE D.O.O., Tolmin (SI)

(21) Appl. No.: 14/182,796

(22) Filed: Feb. 18, 2014

Related U.S. Application Data
(63) Continuation of application No. PCT/SI2012/000037, filed on Jun. 13, 2012.

(30) Foreign Application Priority Data
Aug. 18, 2011 (SI) P-201100324

(51) Int. Cl. H01H 85/02

(52) U.S. Cl. CPC H01H 85/0241
USPC 337/1

(57) ABSTRACT

An air heater fuse for diesel engines for easier starting of a diesel engine inlet air needs to be warmed. In large diesel engines an electric heater is therefore installed into an inlet manifold due to protection in case of excessive electric current and warming of the housing. The fuse of the invention is characterised in that the fusible link (9) is fastened to the air heater by the fastening screw (5), wherein the fusible link (9) is arranged between the head of the fastening screw (5) and the housing (1) of the air heater, and the fusible link (9) is insulated from the shaft of the fastening screw (5) by the insulating spacer (12a) or another insulating material.

### CROSS REFERENCE TO RELATED APPLICATIONS

This Application is a continuation application of Patent Cooperation Treaty Application No. PCT/SI2012/000037, entitled “AIR HEATER FUSE FOR DIESEL ENGINES”, to HIDRIA AET DRU\check{Z}BA ZA PROIZVODNJO V\check{Z}IGNIH SISTEMOV IN ELEKTRONIKE D.O.O., Slovenia, filed on Jun. 13, 2012, which claims priority to Slovenian Patent Application Serial No. P-201100324, filed on Aug. 18, 2011, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHT MATERIAL

Not Applicable.

### BACKGROUND OF THE INVENTION

1. Field of the Invention (Technical Field)

The subject of the invention is an air heater fuse for diesel engines. For an easier start of a diesel engine inlet air needs to be warmed. In large diesel engines an electric heater is installed into an inlet manifold. Due to a possibility of a housing and component elements getting overheated on an electric heater, it is important to have protection in case of excessive electric current and warming of the housing. If the housing gets overheated and system safety is deficient, the component parts of the vehicle around the air heater can ignite, which may lead to ignition of the vehicle or the machine, into which the air heater is installed. This problem becomes even more important in a closed space of a garage or on ships. According to the invention, a fuse is used that prevents ignition of parts in the vicinity of the air heater, the vehicle or the machine, and is fastened to the heater and electrically in series connected with the heater. The fuse melts at a certain temperature and interrupts the current through the air heater. The fuse prevents a possibility of the materials in the vicinity of the heater from getting ignited due to an increased temperature on the housing, for instance over 200° C.

A few known solutions using fuses on heaters are disclosed in patents: JP2007239645, KR20090045139 and GB2305545. The solution of the invention differs from the mentioned solutions especially in that it has a simpler, a more reliable and a cheaper design, consists of less components needed for the functioning of the fuse; less processing and assembling is needed for its manufacturing. The construction allows for a subsequent installation, simpler installation, reliable operation as well as a simple use of the fuse as a spare part.

The housing of the heater gets heated due to the electric current needed for the operation of the heater. A danger that the parts of components of the engine in the vicinity of the heater would ignite or melt appears when there is no air flow through the electric heater fastened to the inlet manifold of the engine. When there is no air flow through the electric heater, the engine is not operable, and due to improper functioning of the control there is a possibility that the heater is still in its operating mode. The heater functions normally even before the functioning of the engine, usually 10 s-10 min, and due to irregularities the heater may function even after the engine stopped operating. As the air heater has a deficient heat discharge from the heating elements in that time, the component parts of the air heater, including the housing, get heated. When the housing reaches a too high temperature due to improper operation of any kind, the component parts of the air heater, including the housing, start burning or melting. The component parts in the vicinity of the air heater, the vehicle or the machine get ignited and melted. The fuse therefore has a very important safety characteristic.

### BRIEF SUMMARY OF THE INVENTION

The present invention relates to an an air heater fuse for diesel engines.

### BRIEF DESCRIPTION OF THE SEVERAL VIEWS OF THE DRAWINGS

The invention will be described by way of embodiments and drawings showing in:

FIG. 1: View of the air heater with a fastened thermal-electric fuse provided without constituent elements between a head of a fastening screw 5, the thermal-electric fuse 9 and the air heater housing 1.

FIG. 2: Top view of the air heater according to FIG. 1.

FIG. 3: Cross-section of the air heater according to FIG. 1 across the fastening screw 5

FIG. 4: View of the air heater with a fastened thermal-electric fuse with several other constituent elements between a head of a fastening screw and the thermal-electric fuse.

FIG. 5: Cross-section of the air heater according to FIG. 4 across the fastening screw.

FIG. 6: Possible variant of the thermal-electric fuse with a connecting cable and constituent elements between the head of a fastening screw and the thermal-electric fuse.

FIG. 7: Possible variant when the current flows from the connecting cable via the thermal-electric fuse to heating bodies.

### DETAILED DESCRIPTION OF THE INVENTION

According to FIGS. 1, 2 and 3, a fusible link 9 is fastened to the air heater with a fastening screw 5 or a rivet. The fastening screw 5 or the rivet may be electric circuit elements or not. The fastening screw 5 or the rivet is by all means a constituent element of the air heater. In a desired operation of the air heater, electric current may always flow through the fusible link 9. The fusible link 9 can always be a circuit element. The fusible link 9 is arranged between a head of the fastening screw 5 or a head of the rivet, with which the fusible link 9 is fastened to the housing of the air heater. Between said individual elements 1, 5 and 9 there are several constituent elements that contribute to the stability of the construction and improve the functioning of the fusible link 9.

Said constituent elements are: a connection 20 of a cable 21, a spring or a spring washer 11, an electrically conductive washer 7d, an insulation washer 8d. Said elements may be arranged between the head of the fastening screw 5 and the thermal-electric fuse 9 or between the housing 1 of the air heater and the thermal-electric fuse 9. With various arrangements of these constituent elements 20, 11, 7d, 8d between the head of the fastening screw 5, the thermal-electric fuse 9 and the housing 1 of the air heater an interruption of the electric current through the air heater can be achieved. The fusible link 9 can be an element of the electric circuit or not.

Some of these constituent elements are intended to improve the contact surface between the fusible link 9 and the housing, the head of the rivet or the screw 5, yet other elements are intended to electrically insulate the circuit elements from those, which are not desired to be the circuit elements.

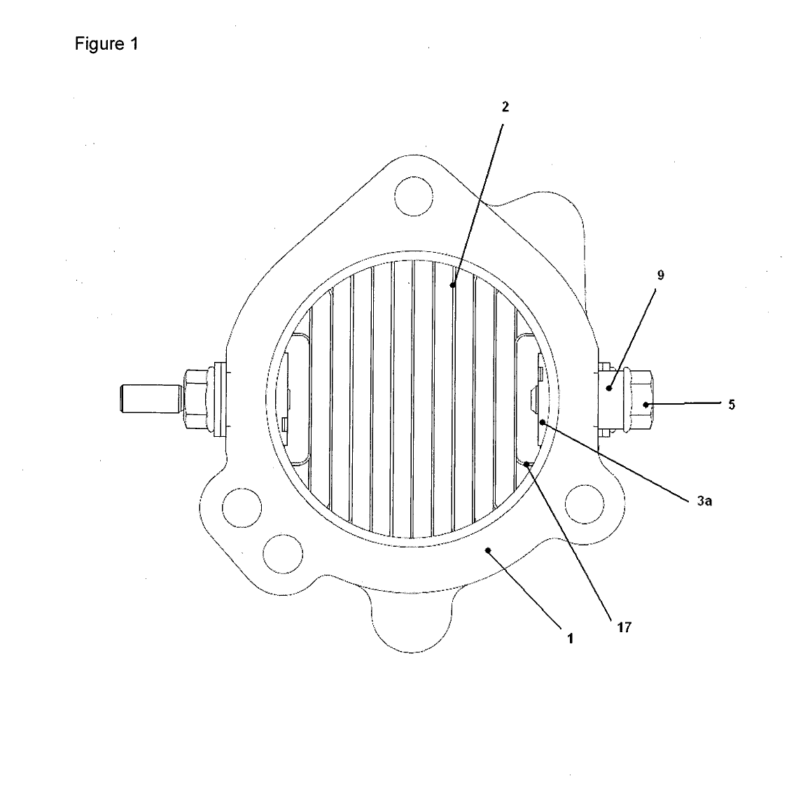

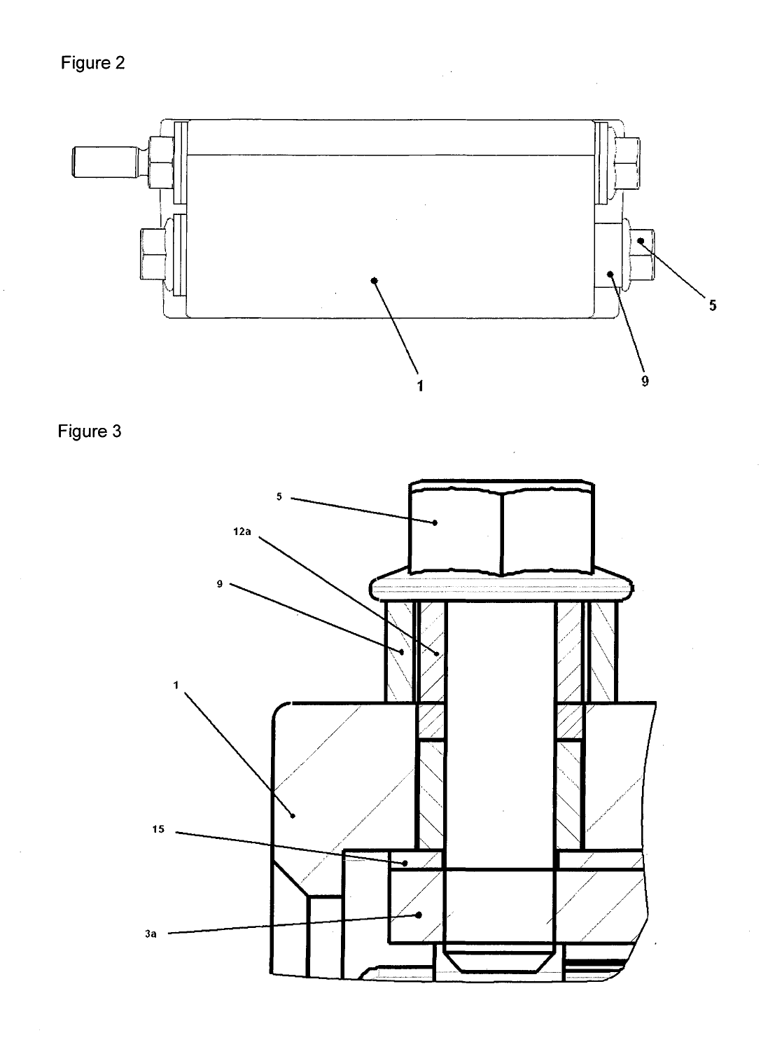

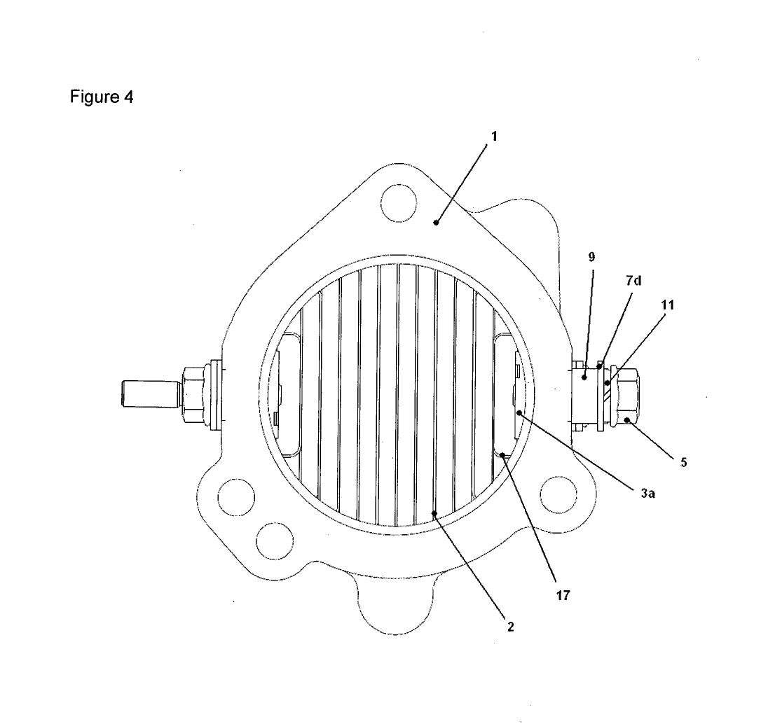

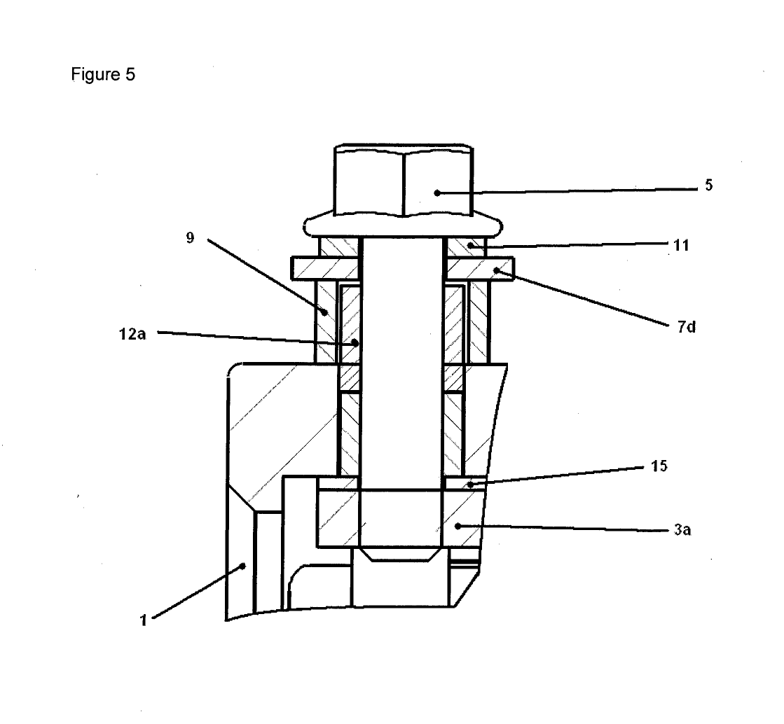

As shown in FIG. 4, one of these constituent elements can also be the spring washer 11 or a spring intended to compensate for creep of the fusible link 9 and ensures a sufficient push force between contact surfaces to the fusible link 9. The spring washer 11 further prevents the fastening screw 5 from getting unscrewed.

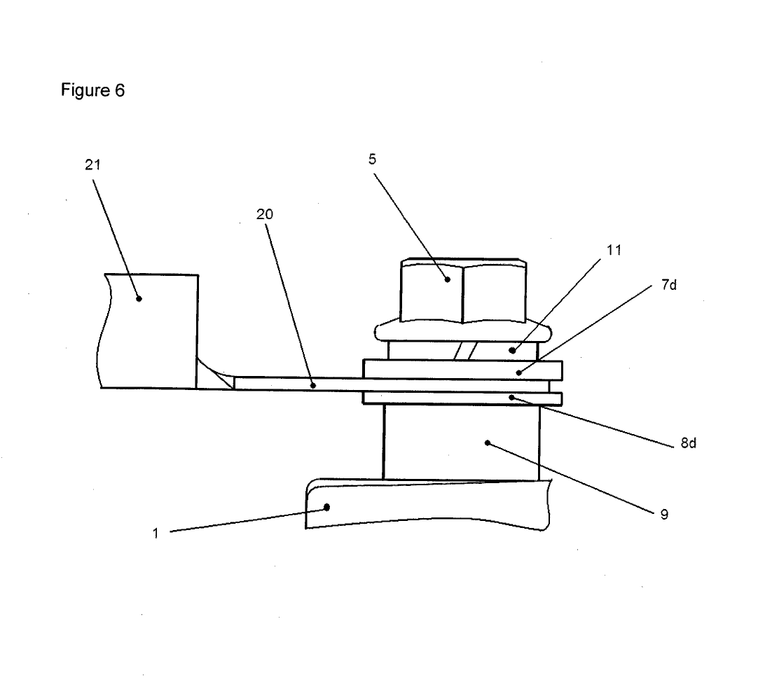

According to FIG. 6, a connection 20 of a connecting cable 21 can be arranged between the head of the fastening screw 5 or the rivet and the fusible link 9 or between the housing of the air heater 1 and the fusible link 9. Electric current flows through the connecting cable 21 which ensures the functioning of the heater when desired. In this variant, the fusible link 9 can be arranged onto the housing 1 of the air heater in a way that it may get melted only due to direct temperature influence. If too high current is present, it has a direct influence over the increased temperature. The fusible link 9 in this variant is not an element of the electric circuit. The housing 1 of the air heater in this variant is insulated from the fusible link 9 by the insulating washer 8b or by another insulating material. When the temperature is high enough, the fusible link 9 melts, the electric circuit is thus interrupted, and the heater stops operating. If the electric current is the reason for melting of the fusible link 9, it causes a temperature increase which causes the fusible link 9 to melt. The influence of the temperature is indirect. The electric current through the heater is interrupted in a way that the cable 21 with the cable connection 20 is moved downwards by means of a spring washer or a spring and gravity. Interruption of the electric current in this variant occurs only when the fastening screw 5 or the rivet is positioned in vertical direction or ±30° from the vertical direction of the screw. The interruption mode is deformation of the fusible link 9 near the melting point temperature of the fusible link 9. The material gets deformed due to temperature and gravity force. The function of the spring washer 11 or the spring is to move away the cable of the connection. The gravity force has a similar function. The contact between the cable connection 20 and the fastening screw 5 or the rivet gets interrupted.

The shaft of the fastening screw 5 and the shaft of the rivet is insulated in all variants or embodiments by an insulating spacer 12a from the rest of constituent elements 11, 20, 7d, 8d arranged between the air heater housing and the fusible link 9 or between the head of the fastening screw and the fusible link 9 which is fastened to the housing by way of the fastening screw 5 or the rivet. The insulation spacer 12a functions as an insulator at least between the surface of the fusible link 9 and the shaft of the fastening screw 5, the rivet or another element, which contributes to a constructional stability of the design that is an electric circuit element. It ascertains that the electric current flows through the shaft of the fastening screw 5, the rivet or another element, which contributes to constructional stability via the head of the fastening screw or the head of the rivet to possible other constituent elements 11, 7d, 8d via the fusible link 9 to the housing 1 of the air heater. There may be clearance between said insulating spacer 12a or another insulating material replacing the insulating spacer and the shaft of the fastening screw 5. There may also be clearance between the fusible link 9 and the insulating spacer 12a or another insulating material. The insulating spacer 12a freely moves in axial direction of the shaft of the fastening screw 5. If there is no insulating material between the shaft of the screw, the rivet or another element that contributes to the constructional stability of the design without an insulating material, the fusible link 9 can be in contact with said element over the entire surface. Therefore a short circuit may occur between the shaft of the fastening screw 5 and the fusible link 9, which can lead to the fuse failing before time for no reason whatsoever, or to an increased temperature, or to its losing the function, for which it is primarily intended for. A variant without the insulating spacer 12a is possible, but the shape of the fusible link 9 needs to be adapted. It can be achieved by one surface of the fusible link being in contact with the head of the fastening screw 5 or another constituent element 11, 20, 7d, 8d, and another surface being in contact with the shaft of the fastening screw 5. The internal diameter of the thermal-electric fuse is then extended so that it does not come in contact with the shaft of the fastening screw. The front surface of the extended part of the fusible link can be in contact with the housing 1 of the air heater or with any other constituent element that links the fusible link 9 with the housing 1 of the air heater. In each variant, good contacts need to be ascertained between individual contact surfaces to the fusible link 9. Regardless of the variant, the fastening screw 5 or the rivet must be insulated from the housing of the air heater. If this insulation is absent, the fuse cannot interrupt the electric current if any of the above-mentioned disturbances in the operation occur. It must be ascertained that the electric current flows from the heating bodies 2 or 17 via connection 3a of the heating bodies, then the fastening screw 5 and possible constituent elements 11, 20, 7d, 8d included in the construction, and the fusible link 9 to the housing 1 of the air heater. The electric current can also flow in the opposite direction, yet in another variant presented by an embodiment.

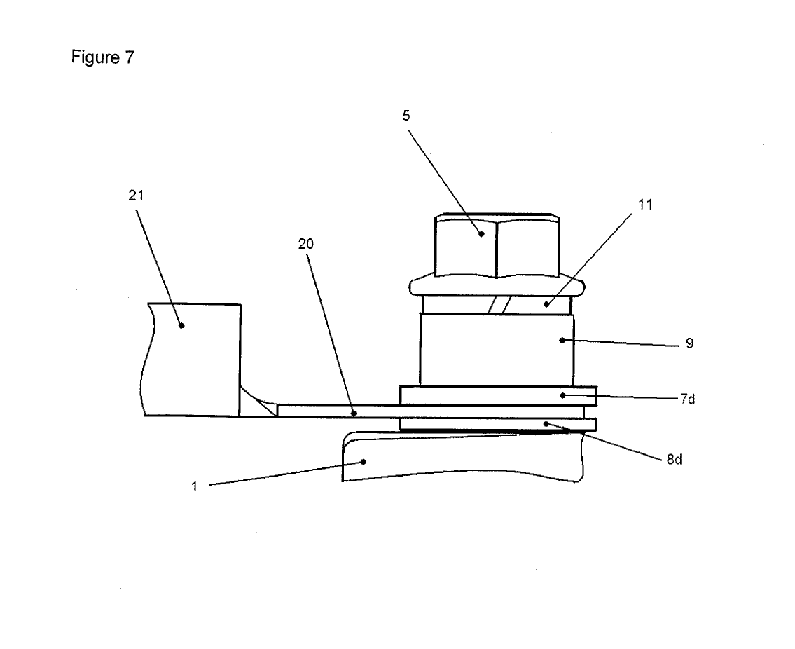

Embodiment: according to FIG. 7, the electric current flows through the cable 21 and reaches the fusible link 9 via connection of the cable 20 and the conductive washer 7d. All three mentioned elements 20, 7d, 9 are insulated from the shaft of the fastening screw 5. The connection of the cable 20 is insulated from the housing 1 of the air heater by means of the insulating washer 8d. The current then flows from the fusible link 9 to the spring or spring washer 11 and via the screw 5 to the connection of the heating bodies 3a, which is also insulated from the housing 1 of the air heater with an insulating washer 15. It means that the heating body 2 or 17 gets uninterruptedly heated. In this variant, the electric current can be interrupted according to the principle of melting of the fusible link 9 or according to the principle of deformation of the fusible link 9 near the melting temperature, whichever occurs first. If the interruption occurs due to the deformation of the fusible link 9, the deformation extends to such extent that there is no more contact between the spring washer 11 or the spring, or the electrically conductive washer 7d—in case of such compositions of elements—and the head of the fastening screw. The electric circuit gets interrupted in both cases. This variant functions regardless of the position of the fastening screw 5. In this assembly, the constituent elements of the fuse can be mutually arranged in a different way to a certain extent and the fuse will still preserve its function.

The electric current must never flow from the fastening screw 5 directly to the housing 1 of the air heater, since the electric current in this case cannot be interrupted in case of faulty operation.

The fuse can consist of one part or several parts which can also be mutually coupled.

The fuse can be fastened to the housing/air heater by a screw or rivet. The screw or rivet can be used not only for the fastening of the fuse but also for the fastening of other elements of the heater to the housing. Only the fusible element 9 without any other constituent elements of the heater can be fastened to the housing or other constituent element of the heater.

The fuse can be fastened to the heater also by coupling with an added material or without it. A screw, a rivet or another element can be used only as a support and ascertains the stability of the coupled elements, constituent parts of the heater. Regardless of how the fuse is fastened, it becomes useless after the fusible link 9 has melted and needs to be replaced. After the melting, the rest of the fuse is removed together with the elements, with which it is fastened to the air heater. The fuse fastened to the air heater by a fastening screw is the most easy to replace. The fastening screw with other elements that are used to improve the operation or ascertain operation and do not melt after the fusible link 9 has melted, need to be unscrewed. If needed, other damaged elements which contribute to the constructional stability and operation or improve the functioning of the fuse also need to be replaced.

The fusible link 9 may be of various shapes and can consist of a large number of components. The fusible link 9 can also be made of a sheet metal or a blank, and also shaped from a wire or a tape. The fuse can comprise several components from metal sheet, blank, wire or tape, which are mutually coupled, or several components that are not coupled and function as a whole by the physical principles described above.

The material of the fusible link 9 has the following properties:
electric conductivity even in a liquid state,
melting temperature between 190° C. and 270° C.,
capability of creeping or deformation near melting temperature, and
capability of creeping above melting temperature.

The fuse of the air heater of diesel engines, where the heater is arranged in an inlet manifold of the engine and the fuse is arranged on the housing (1) of the heater is characterised in that the fusible link (9) is fastened to the air heater by the fastening screw (5), wherein the fusible link (9) is arranged between the head of the fastening screw (5) and the housing (1) of the air heater, and the fusible link (9) is insulated from the shaft of the fastening screw (5) by the insulating spacer (12a) or another insulating material. The fusible link (9) is made of a material that is electrically conductive and has a capability of creep and deformation between the temperature of the fusible link (9) 190° C. and 270° C. The fuse has an added spring washer (11) or a washer between the head of the fastening screw (5) and the fusible link (9), and the fusible link is in the electric circuit of the air heater; between the spring washer (11) or the spring and the fusible element (9) an element intended to increase the stability of the construction is added, it is preferably an electrically conductive washer (7d) and the fusible link (9) is insulated from the shaft of the fastening screw (5) by the insulating spacer (12a) or another insulating material. Between the fusible element (9) and the head of the fastening screw (5) the fuse has in series the spring washer (11) or a spring, the electrically conductive washer (7d), the cable connection (20) which is not insulated from the shaft of the fastening screw (5) and to which the cable (21) and the insulating washer (8d) are connected, said insulating washer (8d) being arranged above the fusible link (9), and the fusible element (9) is not the electric circuit element. Between the fusible link (9) and the housing (1) of the air heater the fuse has in series the cable connection (20), to which the cable (21) is fastened, and is insulated from the shaft of the fastening screw (5) by the insulating spacer (12a) or another insulating material and the insulating washer (8d). Between the fusible link (9) and the housing (1) of the air heater the fuse has in series the electrically conductive washer (7d) or another electrically conductive element which is insulated from the shaft of the fastening screw (5) by the insulating spacer (12a) or another insulating material, the cable connection (20), to which the cable (21) is fastened and is insulated from the shaft of the fastening screw (5) by the insulating spacer (12a) or another insulating material and the insulating washer (8d).

What is claimed is:

1. A fuse of an air heater of diesel engines, wherein the heater is arranged in the inlet manifold of the engine, and the fuse is arranged on the housing of the air heater, said fuse comprising a fusible link fastened to the air heater by a fastening screw, wherein the fusible link is arranged between the head of the fastening screw and the housing of the air heater, and wherein the fusible link is insulated from the shaft of the fastening screw by an insulating material.

2. The fuse of an air heater according to claim 1, wherein the fusible link is made of a material that is electrically conductive and has a capability of creep and deformation between the temperature of the fusible link of 190° C. to 270° C.

3. The fuse of an air heater according to claim 2, wherein a washer is added between the head of the fastening screw and the fusible link, and the fusible link is in the electric circuit of the air heater, and wherein between the spring washer or the spring and the fusible element an element to increase stability of the construction is added and the fusible link is insulated from the shaft of the fastening screw by the insulating material.

4. The fuse of an air heater according to claim 3, wherein between the fusible element and the head of the fastening screw there are in series a spring, an electrically conductive washer, a cable connection which is not insulated from the shaft of the fastening screw and to which a cable and an insulating washer are connected, said insulating washer being arranged above the fusible link, and wherein the fusible element is not an electric circuit element.

5. The fuse of an air heater according to claim 1, wherein between the fusible link and the housing of the air heater there are in series a cable connection, to which a cable is fastened, and which is insulated from the shaft of the fastening screw by the insulating material and an insulating washer.

6. The fuse of an air heater according to claim 1, wherein between the fusible link and the housing of the air heater the fuse has in series an electrically conductive element which is insulated from the shaft of the fastening screw by the insulating material, a cable connection, to which a cable is fastened, and which is insulated from the shaft of the fastening screw by the insulating material and an insulating washer.

7. The fuse of an air heater according to claim 1 wherein said insulating material comprises an insulating spacer.

8. The fuse of an air heater according to claim 3 wherein said washer is a spring washer.

9. The fuse of an air heater according to claim 3 wherein said element to increase stability is an electrically conductive washer.

10. The fuse of an air heater according to claim 4 wherein said spring is a spring washer.
